(19) United States
(12) Patent Application Publication
(10) Pub. No.: US 2024/0195034 A1
(43) Pub. Date: Jun. 13, 2024

(54) BATTERY TERMINAL

(71) Applicants: Hyundai Motor Company, Seoul (KR); Kia Corporation, Seoul (KR)

(72) Inventors: Jongjoo KIM, Suwon-si (KR); Heegun YANG, Seongnam-si (KR)

(73) Assignees: Hyundai Motor Company, Seoul (KR); Kia Corporation, Seoul (KR)

(21) Appl. No.: 18/371,316

(22) Filed: Sep. 21, 2023

(30) Foreign Application Priority Data
Dec. 7, 2022 (KR) 10-2022-0169954

(51) Int. Cl. H01M 50/588; H01M 10/052; H01M 10/06; H01M 50/552; H01M 50/567; H01M 50/59

(52) U.S. Cl. CPC H01M 50/588; H01M 10/052; H01M 10/06; H01M 50/552; H01M 50/567; H01M 50/59; H01M 2200/00; H01M 2220/20

(57) ABSTRACT

A battery terminal includes a post terminal provided to electrically connect a cable to a post of a battery by being coupled to the post of the battery by a compressing and clamping force applied thereto in a state in which the cable is connected to the post terminal, and a short-prevention member detachably provided on the post terminal and provided as a high-resistance element to prevent spark generation when assembled to the post.

### CROSS-REFERENCE TO RELATED APPLICATION(S)

The present application claims priority to Korean Patent Application No. 10-2022-0169954, filed on Dec. 7, 2022, the entire contents of which is incorporated herein for all purposes by this reference.

### BACKGROUND OF THE PRESENT DISCLOSURE

### Field of the Present Disclosure

The present disclosure relates to a battery terminal, and more particularly, to a battery terminal capable of preventing spark generation when assembled to a post of a vehicle battery.

### Description of Related Art

In general, a vehicle is essentially provided with a battery for providing power to various electric components mounted in the vehicle, such as a starting motor, a lighting device, and a multimedia device.

A vehicle battery is provided in a form of a secondary battery capable of being charged and discharged, and thus is charged by receiving power generated from a generator through a cable, and discharged while supplying the charged power to each electric component through a cable.

To use such a battery, a cable needs to be connected to a post of the battery. Accordingly, in a state in which a battery terminal made of a conductor is fixed to the post to be electrically connected, the cable connected to the battery terminal is connected to an electric component so that battery power is supplied to the electric component through the battery terminal and the cable.

The battery terminal is mounted and fixed to the post in a compressing and clamping manner, but the present manner has problems in that a coupling force is weakened by vibration or an external force applied thereto and the post is damaged by too strong coupling, and thus to properly solve these problems, battery terminals having various structures have been developed and used.

Recently, the replacement of lead-acid batteries (batteries using lead and sulfuric acid) to lithium batteries is expanding to reduce the weight of vehicles, improve battery durability, and secure package space.

However, because the lithium batteries have lower resistance than the lead-acid batteries, when the battery terminal is connected to the post, strong sparks may occur, which may act as a risk factor for injury.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery terminal configured for preventing spark generation when connected to a low-resistance post of a lithium battery.

Additional aspects of the present disclosure will be set forth in part in the description which follows, and in part, will be obvious from the description, or may be learned by practice of the present disclosure.

In accordance with an aspect of the present disclosure, a battery terminal includes a post terminal provided to electrically connect a cable to a post of a battery by being coupled to the post of the battery by a compressing and clamping force applied thereto in a state in which the cable is connected to the post terminal, and a short-prevention member detachably provided on the post terminal and provided as a high-resistance element to prevent spark generation when assembled to the post.

The short-prevention member may be assembled to the post terminal when the battery is a lithium battery and removed from the post terminal when the battery is a lead-acid battery.

The short-prevention member may be provided as dark plated steel.

The short-prevention member may be assembled to be disposed at a lower end portion of the post terminal to first come into contact with the post when the post terminal is assembled to the post.

The post terminal may include a compression portion on which an accommodation hole is formed to allow the post to be inserted therein and including a shape of cylinder with an open portion formed by one side cut, a clamping portion formed to extend from a first side of the compression portion on which the open portion is formed and to which a fastening member is provided, a fastening portion formed to protrude from a second side of the compression portion so that a cable terminal is coupled thereto, and a mounting protrusion protruding outward in a radial direction from the compression portion so that the short-prevention member is selectively mounted thereto.

An uneven portion including a predetermined pattern in a longitudinal direction may be formed on an internal circumferential surface of the compression portion, and the uneven portion may be formed along a circumferential direction of the compression portion.

The short-prevention member may include a close contact portion formed to be in contact with a lower surface of the compression portion, and a mounting portion formed to protrude from the close contact portion in a longitudinal direction to be coupled to the mounting protrusion.

The close contact portion may be provided to include a shape corresponding to the lower surface of the compression portion.

A mounting hole including a shape corresponding to the mounting protrusion may be formed on the mounting portion so that the mounting protrusion is inserted therein.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating that a battery terminal is assembled to a post of a battery according to an exemplary embodiment of the present disclosure;

FIG. 2 is a view exemplarily illustrating a state in which the battery terminal of FIG. 1 is assembled to the post;

FIG. 3 is a bottom perspective view of the battery terminal according to an exemplary embodiment of the present disclosure;

FIG. 4 is a view exemplarily illustrating a point where the battery terminal first comes into contact with the post when assembled to the post according to an exemplary embodiment of the present disclosure; and

FIG. 5 is a cross-sectional view exemplarily illustrating the state in which the battery terminal is assembled to the post according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, an exemplary embodiment of the present disclosure will be described in detail with reference to the accompanying drawings. The exemplary embodiment described below is provided by way of example so that those skilled in the art will be able to fully understand the spirit of the present disclosure. The present disclosure is not limited to the exemplary embodiment described below, but may be embodied in other forms. To clearly explain the present disclosure, parts not related to the description are omitted from the drawings, and sizes of components may be exaggerated for convenience.

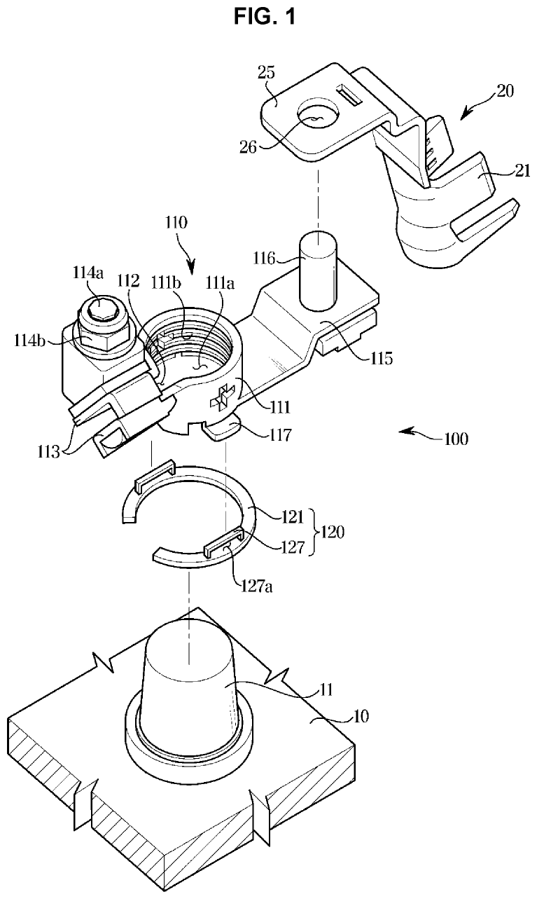

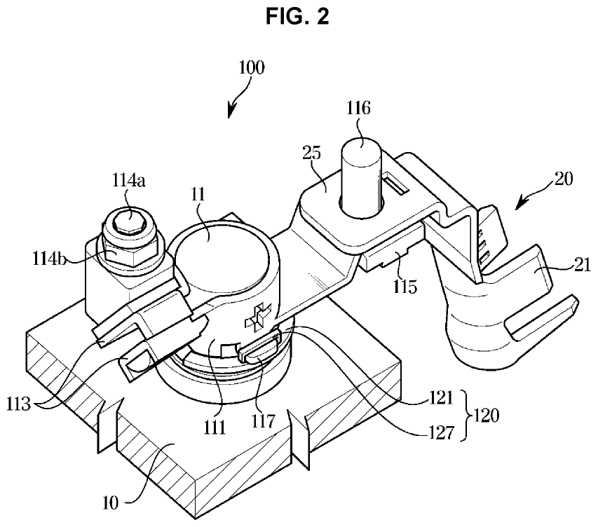

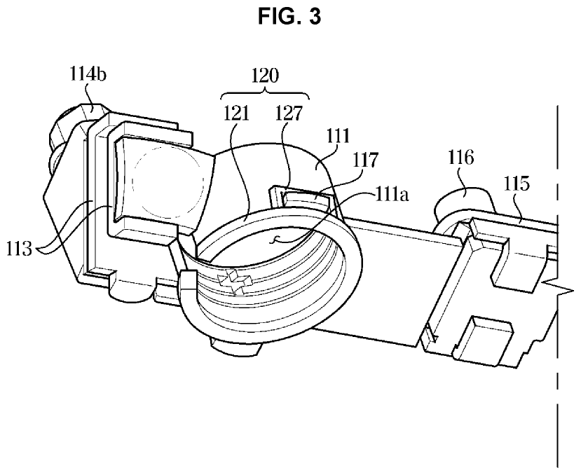

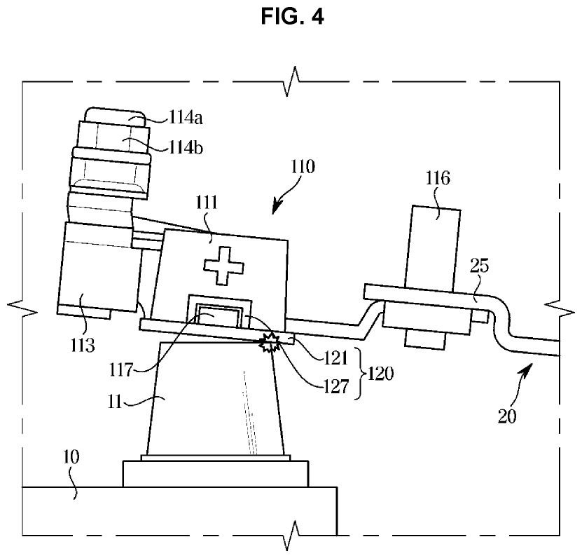

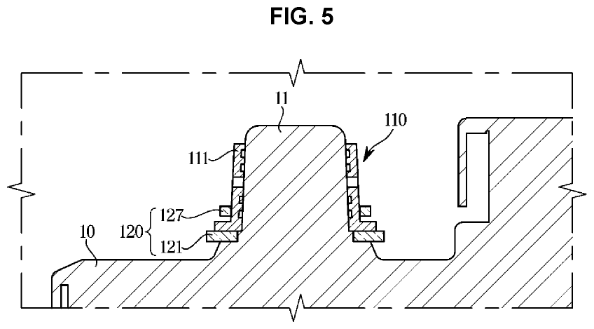

FIG. 1 is a view exemplarily illustrating that a battery terminal is assembled to a post of a battery according to an exemplary embodiment of the present disclosure, FIG. 2 is a view exemplarily illustrating a state in which the battery terminal of FIG. 1 is assembled to the post, FIG. 3 is a bottom perspective view of the battery terminal according to an exemplary embodiment of the present disclosure, FIG. 4 is a view exemplarily illustrating a point where the battery terminal first comes into contact with the post when assembled to the post according to an exemplary embodiment of the present disclosure, and FIG. 5 is a cross-sectional view exemplarily illustrating the state in which the battery terminal is assembled to the post according to an exemplary embodiment of the present disclosure.

Referring to FIG. 1, FIG. 2, FIG. 3, FIG. 4, and FIG. 5, a battery terminal 100 according to an aspect of the present disclosure may include a post terminal 110 provided to be assembled to a post 11 of a battery 10, and a short-prevention member 120 detachably mounted to the post terminal 110.

According to an exemplary embodiment of the present disclosure, the short-prevention member 120 may be assembled to the post terminal 110 when the battery 10 is a lithium battery, and may be removed from the post terminal 110 when the battery 10 is a lead-acid battery. That is, when applied to a generally used lead-acid battery, only the post terminal 110 according to an exemplary embodiment of the present disclosure may be assembled and used to the post 10, and when applied to a lithium battery, the post terminal 110 to which the short-prevention member 120 is assembled may be assembled and used to the post 10. Therefore, hereinafter, the application of the battery terminal 100 according to an exemplary embodiment of the present disclosure to a lithium battery will be described as an example.

The post terminal 110 is configured to electrically connect a cable to the post 11 by being coupled to the post 11 of the battery 10 in a compressing and clamping manner in a state in which the cable is connected thereto. The post terminal 110 may include a compression portion 111 provided to be assembled to the post 11, a clamping portion 113 formed to extend from a first side of the compression portion 111, a fastening portion 115 formed to protrude from the other side of the compression portion 111, and a mounting protrusion 117 formed to protrude in a radial direction from the compression portion 111.

An accommodation hole 111a is formed in the center portion of the compression portion 111 so that the post 11 is inserted therein. Accordingly, the compression portion 111 is electrically connected to the battery 10 by compressing an external circumferential surface of the post 11. Furthermore, one side of the compression portion 111 may be cut to form an open portion 112. That is, as the compression portion 111 includes a structure in which one side is open, the compression portion 111 may be opened or closed toward opposite sides through the open portion 112. Accordingly, it is easy to assemble and separate the compression portion 111 to or from the post 11.

The compression portion 111 includes a shape of cylinder. The compression portion 111 is illustrated as including a tapered shape, but is not limited thereto, and may have any shape as long as it includes a shape which may be assembled to the post 11.

An uneven portion 111b including a predetermined pattern in a longitudinal direction may be formed on an internal circumferential surface of the compression portion 111. The uneven portion 111b may be formed along a circumferential direction of the compression portion 111. Therefore, assembly is possible when the compression portion 111 is assembled to the post 11. Although not shown, a protrusion may be formed on the post 11 to be inserted into at least one groove formed at the uneven portion 111b of the compression portion 111, or a groove may be formed on the post 11 to be inserted into at least one protrusion formed at the uneven portion 111b of the compression portion 111.

The clamping portion 113 may be formed to extend from a first side of the compression portion 111. Appropriately, the clamping portion 113 may be formed to extend from each of the opposite end portions of one side of the compression portion 111 at which the open portion 112 is formed. That is, the clamping portions 113 may be provided as a pair. The clamping portion 113 is fastened through a fastening member so that the compression portion 111 may be inserted into and fixed to the post 11. The fastening member may include a fastening bolt 114a and a fastening nut 114b. Therefore, the internal circumferential surface of the compression portion 111 may compress the external circumferential surface of the post 11 as the open opposite end portions of the compression portion 111 are closed by a tightening force applied thereto when the fastening bolt 114a and the fastening nut 114b are fastened in a state in which the pair of clamping portions 113 are spread apart from each other before fastening of the fastening member.

The fastening portion 115 may be formed to protrude from the other side of the compression portion 111. The fastening portion 115 may be formed on the opposite side of the clamping portion 113 with respect to the compression portion 111 to have a phase difference of 180 degrees with the clamping portion 113. A fixing bolt 116 is fixed to the fastening portion 115 so that a cable terminal 20 is coupled thereto.

The cable terminal 20 may include a cable connection portion 21 provided so that the cable is connected thereto and a terminal connection portion 25 provided to be connected to the post terminal 110.

The cable connection portion 21 may fix the cable by compressing an end portion of the cable inserted into an inside thereof.

The terminal connection portion 25 may be integrally formed with the cable connection portion 21 to be electrically connected to the post terminal 110. A fastening hole 26 through which the fixing bolt 116 may pass is formed on the terminal connection portion 25. Accordingly, as a nut is fastened to the fixing bolt 116 in a state in which the fixing bolt 116 is inserted into the fastening hole 26 of the cable terminal 20, the cable terminal 20 is fixed to the post terminal 110. Therefore, after the battery terminal 100 is fastened to the post 11, the cable is fixed to the cable terminal 20 to supply power to each electric component.

The mounting protrusion 117 may protrude outward in the radial direction from the compression portion 111. It is obvious that the mounting protrusion 117 is spaced from each other so as not to interfere with the clamping portion 113 and the fastening portion 117 formed on the compression portion 111. The mounting protrusions 117 may be provided as a pair to have the phase difference of 180 degrees for stable coupling with the short-prevention member 120, which will be described later, but are not limited thereto, and the number thereof may be selectively increased or decreased.

The post terminal 110 as described above may be connected to the cable terminal 20 and assembled to the post 11 when applied to a lead-acid battery, and as described above, may be assembled to the post 11 after the short-prevention member 120 is provided on the mounting protrusion 117 when applied to a lithium battery.

The short-prevention member 120 may be detachably provided on the post terminal 110. The short-prevention member 120 may be made of a high-resistance element to prevent spark generation when assembled to the post 11. Furthermore, the short-prevention member 120 may be assembled to be disposed at a lower end portion of the post terminal 110 to first come into contact with the post terminal 11 when the post terminal 110 is assembled to the post 11. The short-prevention member 120 may include a close contact portion 121 provided below the compression portion 111 and a mounting portion 127 protruding from the close contact portion 121.

The close contact portion 121 may be formed to be in close contact with a lower surface of the compression portion 111. Thus, the close contact portion 121 may be provided to include a shape corresponding to the lower surface of the compression portion 111. That is, as the compression portion 111 is provided to include a shape in which one side is spaced apart by the open portion 112, the close contact portion 121 may also be formed so that a portion thereof is cut at a position corresponding to the open portion 112.

The mounting portion 127 may be formed to protrude from the close contact portion 121 in the longitudinal direction thereof. The mounting portion 127 is a portion coupled to the mounting protrusion 117, and a mounting hole 127a including a shape corresponding to the mounting protrusion 117 may be formed on the mounting portion 127. Furthermore, the mounting portion 127 may be formed to protrude so that the mounting protrusion 117 is inserted into the mounting hole 127a in a state in which the close contact portion 121 is in close contact with the lower surface of the compression portion 111.

The short-prevention member 120 may be provided as dark plated steel.

Hereinafter, a process of assembling the battery terminal 100 provided with the short-prevention member 120 to the post 11 will be described.

First, the short-prevention member 120 is assembled to the post terminal 110 before the post terminal 110 is assembled to the post 11. Furthermore, the cable terminal 20 may be provided on the post terminal 110.

In the present state, as illustrated in FIG. 4 when the battery terminal 100 is assembled to the post 11, the lower end portion of the post terminal 110, that is, the short-prevention member 120 and the post 11 are first brought into contact. Accordingly, an equal potential is generated between the three objects of the short-prevention member 120, which is a high-resistance element, the post 11 and the battery terminal 100, and spark generation is prevented due to the high-resistance element (short-prevention member) which is first contacted.

When the post terminal 110 is completely accommodated on the post 11, that is, when the fastening bolt 114a and the fastening nut 114b are fastened in a state in which the post 11 is inserted into the accommodation hole 111a of the compression portion 111, as the pair of clamping portions 113 are tightened to be close to each other, the internal circumferential surface of the compression portion 111 presses the external circumferential surface of the post 11 and is fixed thereto.

When the post terminal 110 is completely accommodated on the post 11 and the assembly is completed, because the post 11 and the post terminal 110 are directly connected, current conduction does not pass through the short-prevention member 120, so that the current conduction becomes stable after assembling. That is, as illustrated in FIG. 5, an internal surface of the close contact portion 121 of the short-prevention member 120 is supported on a stepped portion provided at a lower end portion of the post 11, and the compression portion 111 comes into close contact with the external circumferential surface of the post 11.

Furthermore, when the post 11 and the battery terminal 100 are separated for battery A/S or electrical component inspection, because disassembly is performed in the reverse order of assembly, due to the contact between the short-prevention member 120 and the post 11 before final separation, sparks are not generated as in the case of assembly.

As is apparent from the above, a battery terminal according to an exemplary embodiment of the present disclosure can prevent spark generation when connected to a low-resistance post of a lithium battery, reducing injury and psychological anxiety of a worker.

Furthermore, the battery terminal according to an exemplary embodiment of the present disclosure may be detachably provided with a high-resistance element (short-prevention member) for preventing spark generation. Therefore, the battery terminal may be used in common to a lead-acid battery and the lithium battery by being used without mounting the high-resistance element when applied to the lead-acid battery.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery terminal comprising:
a post terminal provided to electrically connect a cable to a post of a battery by being coupled to the post of the battery by a compressing and clamping force applied thereto in a state in which the cable is connected to the post terminal; and
a short-prevention member detachably provided on the post terminal and provided as a high-resistance element to prevent spark generation when assembled to the post.

2. The battery terminal of claim 1, wherein the short-prevention member is assembled to the post terminal when the battery is a lithium battery and removed from the post terminal when the battery is a lead-acid battery.

3. The battery terminal of claim 1, wherein the short-prevention member is provided as dark plated steel.

4. The battery terminal of claim 1, wherein the short-prevention member is assembled to be disposed at a lower end portion of the post terminal to first come into contact with the post when the post terminal is assembled to the post.

5. The battery terminal of claim 1, wherein the post terminal includes:
a compression portion on which an accommodation hole is formed to allow the post to be inserted therein and including a shape of cylinder with an open portion formed by one side thereof cut;
a clamping portion formed to extend from a first side of the compression portion on which the open portion is formed and to which a fastening member is provided;
a fastening portion formed to protrude from a second side of the compression portion so that a cable terminal is coupled thereto; and
a mounting protrusion protruding outward in a radial direction from the compression portion so that the short-prevention member is selectively mounted thereto.

6. The battery terminal of claim 5, wherein the post terminal further includes an uneven portion,
wherein the uneven portion including a predetermined pattern is formed on an internal circumferential surface of the compression portion, and
wherein the uneven portion is formed along a circumferential direction of the compression portion.

7. The battery terminal of claim 6, wherein the uneven portion of the post terminal includes at least one protrusion and at least a groove formed on the post is coupled to the at least one protrusion.

8. The battery terminal of claim 6, wherein the uneven portion of the post terminal includes at least one groove and at least a protrusion formed on the post is coupled to the at least one groove.

9. The battery terminal of claim 5, wherein the short-prevention member includes:
a close contact portion formed to be in contact with a lower surface of the compression portion; and
a mounting portion formed to protrude from the close contact portion to be selectively coupled to the mounting protrusion.

10. The battery terminal of claim 9, wherein the close contact portion of the short-prevention member is in a shape of “C”.

11. The battery terminal of claim 9, wherein the close contact portion is provided to include a shape corresponding to the lower surface of the compression portion.

12. The battery terminal of claim 9, wherein a mounting hole is formed on the mounting portion so that the mounting protrusion is inserted therein.

13. The battery terminal of claim 5, wherein the fastening portion is formed on an opposite side of the clamping portion with respect to the compression portion to have a phase difference of 180 degrees with the clamping portion.

14. The battery terminal of claim 13, further including a fixing bolt fixed to the fastening portion so that the cable terminal is coupled thereto.

15. The battery terminal of claim 5, wherein the mounting protrusion is provided as a pair to have a phase difference of 180 degrees for coupling with the short-prevention member.

16. The battery terminal of claim 5,
wherein the fastening member includes a fastening bolt and a fastening nut, and
wherein an internal circumferential surface of the compression portion compresses an external circumferential surface of the post as open opposite end portions of the compression portion are closed by a tightening force applied thereto when the fastening bolt and the fastening nut are fastened.
